(19) United States
(12) Patent Application Publication
(10) Pub. No.: US 2008/0318611 A1
(43) Pub. Date: Dec. 25, 2008

(54) Communication System, Apparatus and Method of Operating a Communication System

(75) Inventors: Matthew P. J. Baker, Canterbury (GB); Paul Bucknell, Brighton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,096

(22) PCT Filed: Mar. 21, 2006
(86) PCT No.: PCT/IB2006/050861

§ 371 Date: Sep. 19, 2007

(30) Foreign Application Priority Data
Mar. 24, 2005 (GB) 0506082.7

(51) Int. Cl. H04Q 7/20

(52) U.S. Cl. 455/522

(57) ABSTRACT

A radio communication system comprises a first radio station (100) and one or more second radio stations (200). When transmitting a signal, the second radio station (200) employs power ramping to increase its transmit power up to a maximum value in a sequence of power steps. The first radio station (100) is able to control the maximum transmit power and rate of increase of transmit power of the second station (200) by transmitting indications of these parameters to the second station (200).

The invention relates to a radio communication system, to a method of operating a radio communication system, to radio stations for use in a radio communication system, and to a signal. The invention has particular application in the field of mobile communications, for example to systems such as the Universal Mobile Telecommunication System (UMTS).

It is known for a radio communication system to employ a plurality of data transmission rates transmitted at a plurality of power levels, in order to provide flexibility to cater for a variety of applications and propagation conditions. Transmission at a higher rate may take place at a higher transmission power level than transmission at a lower rate.

When a transmitting station commences transmission its signal may cause interference to other radio stations. Higher transmission power levels are more likely to cause interference than lower power levels.

Also, a receiving station needs to make processing resources available to process a received signal, and transmissions should be controlled to enable the receiving station to deploy sufficient resources to receive the signal. When a higher transmission rate is employed, more processing resources need to be made available than when a lower transmission rate is employed. Starting to transmit at a higher rate than the available receiver resources can support can cause buffers to overflow and data to be lost.

In order to reduce these problems, it is known for a radio station to increase the data rate and transmission power of a signal in a step-wise manner up to a predetermined maximum data rate and transmission power. In this way, the occurrence of sudden large changes in transmission power and in processing requirements can be reduced. However, delays incurred while waiting to ascertain whether sufficient processing resources are available can result in reduced system efficiency and degraded quality of service.

An object of the invention is to enable improved control of radio transmissions.

According to a first aspect of the invention there is provided a method of operating a radio communication system comprising a first station and a second station, the method comprising:

at the first station, transmitting a first signal comprising a first indication of a maximum transmission power and a second indication of a selected one of a first plurality of rates of increase of transmission power; and
at the second station, receiving the first signal and transmitting a second signal using a step-wise increasing transmission power to approach the indicated maximum transmission power at a rate of increase selected in response to the received second indication.

According to a second aspect of the invention there is provided a radio station comprising:

receiving means for receiving a first signal comprising a first indication of maximum transmission power and a second indication of a selected one of a first plurality of rates of increase of transmission power,
transmitting means for transmitting a second signal, and
control means adapted to increase step-wise the transmission power of the second signal to approach the indicated maximum transmission power at a rate of increase selected in response to the received second indication.

According to a third aspect of the invention there is provided a radio station comprising control means adapted to generate for transmission a first signal comprising a first indication of a maximum transmission power and a second indication of a selected one of a first plurality of rates of increase of transmission power, and transmission means for transmitting the first signal.

According to a fourth aspect of the invention there is provided a radio communication system comprising a first radio station according the third aspect of the invention and a second radio station according to the second aspect of the invention.

According to a fifth aspect of the invention there is provided a signal comprising a first indication of a maximum transmission power and a second indication of a selected one of a plurality of rates of increase of transmission power.

By transmitting from the first station an indication of a maximum transmission power and an indication of a selected one of a plurality of rates of increase of transmission power, and by the second station increasing its transmission power to approach the indicated maximum value at a rate dependent on the indicated rate, the first station is able to exert improved control over the transmission of the second station. The first station is able to control not only the maximum power transmitted by the second station but also the rate of increase of power, and therefore is able to reduce the impact of interference caused by the transmissions.

Further, the first station is able to control the rate of increase of transmission power of the second station in a way which takes into account the indicated maximum transmission power.

In a communication system comprising a plurality of second stations, the rate of increase may depend on the number of second stations that require to transmit, thereby enabling the impact of interference caused by the sum of the transmissions to be reduced.

In a communication system comprising a plurality of second stations, the first station may control all of the second stations using the same transmitted indications, or may transmit different indications to different second stations or different groups of second stations. In this latter case the first station may ensure that the second stations do not all reach their maximum transmit power at the same time, thereby reducing the impact of any interference caused by the transmissions.

The second station may increase its transmission data rate when it increases its transmission power. In this case, when the first station exerts control over the rate of increase of transmission power of one or more second stations, it can also exert control over the demand for processing resources for processing the signals received from the second stations.

The invention will now be described, by way of example, with reference to the accompanying drawings wherein:

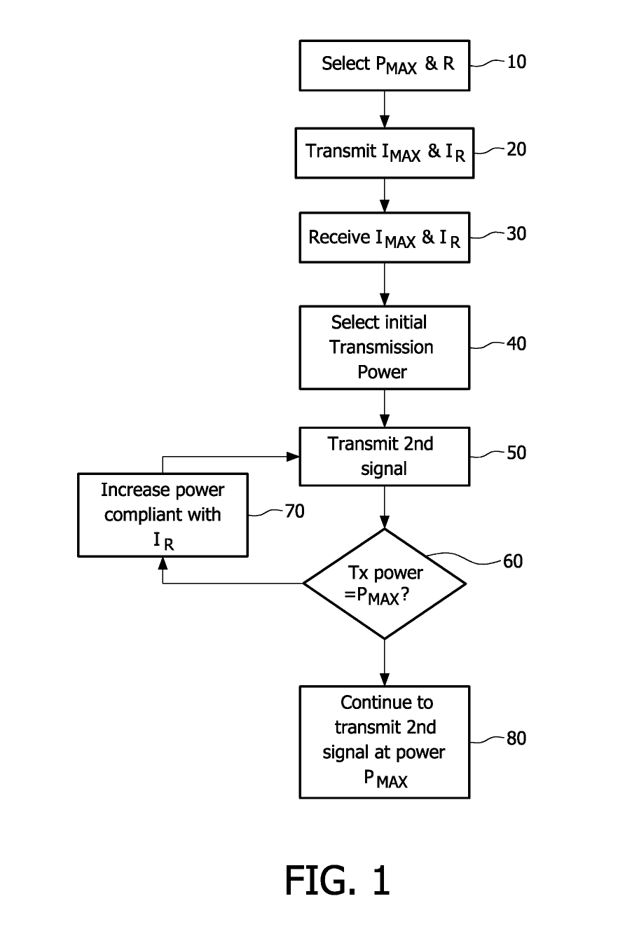

FIG. 1 is a flow chart for a method of operating a radio communication system comprising a first and a second radio station;

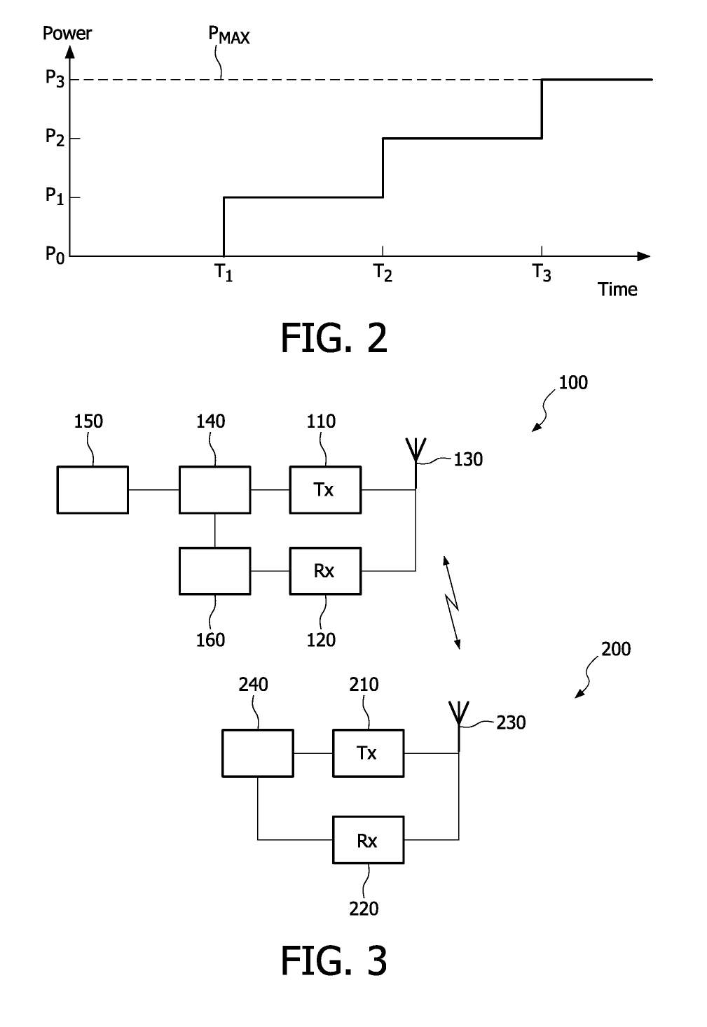

FIG. 2 is a timing diagram illustrating an increasing transmission power; and

FIG. 3 is a block schematic diagram of a radio communication system.

Referring to FIG. 1, the method commences at step 10 with the first radio station, which may be a base station, selecting a maximum transmission power P_{MAX} and a rate of increase of transmission power R, from a plurality of available values of each, which it requires a second radio station, which may be a mobile terminal, to comply with. The selection may be based on an assessment of interference potential of transmission by the second station and available processing resources for processing a signal received from the second radio station.

At step 20 the first radio station transmits a first signal comprising an indication I_{PMAX} of the selected maximum transmission power P_{MAX} and an indication I_{R} of the selected rate of increase of transmission power R. At step 30 the second radio station receives the indications I_{PMAX} and I_{R}.

At step 40 the second radio station selects a transmission power level lower than the maximum transmission power level P_{MAX} indicated by I_{PMAX} and at step 50 commences transmission of a second signal at that selected power level. The second signal comprises data. In FIG. 2, this transmission commences at time T₁ and the initial transmission power level is P₁.

In FIG. 1, at step 60 the second radio station determines whether its current transmit power level is equal to the maximum transmission power level P_{MAX} indicated by I_{PMAX}. If the current transmit power level is below P_{MAX} flow proceeds to step 70.

At step 70 the second radio station increases its transmit power by a step value, ensuring that the rate of increase of transmit power is equal to the rate of increase of transmit power R indicated by I_{R}. In FIG. 2, the transmit power is increased at time T₂ to a level P₂, and the rate of increase of transmit power may for example be calculated as (P₂−P₁)/(T₂−T₁). Other methods may alternatively be used to derive the rate of increase of transmit power, for example using averaging over a different time period In FIG. 1, flow then reverts to step 50 where the transmission of the second signal continues at transmit power level P₂.

The loop consisting of steps 60, 70 and 50 is repeated as often as necessary until at step 60 the transmit power level is equal to the maximum transmission power level P_{MAX} indicated by I_{PMAX}. Flow then proceeds to step 80 where the data transmission continues at this maximum level. In FIG. 2 one power step is illustrated occurring at time T₃ up to a transmit power level P₃; the rate of increase of transmit power is (P₃−P₂)/(T₃−T₂). Power level P₃ is equal to P_{MAX} so subsequently the data transmission continues at this maximum level.

Referring to FIG. 3, there is illustrated a radio communication system comprising a first radio station 100 and a second radio station 200. For example, the first radio station (100) may be a base station and the second radio station (200) may be a mobile terminal in a mobile communication system. The first radio station 100 comprises a control means 140 for selecting a maximum transmission power P_{MAX} and a rate of increase of transmission power R, from a plurality of available values of each stored in a storage device 150. The control means 140 may, for example, be a controller or control device such as a microcontroller. The selection may be based on an assessment of interference potential of transmissions compliant with P_{MAX} and R and of available processing resources, represented in FIG. 3 by a processor 160, for processing received transmissions compliant with P_{MAX} and R. The control means 140 is adapted to generate a first signal comprising an indication I_{PMAX} of the selected maximum transmission power P_{MAX} and an indication I_{R} of the selected rate of increase of transmission power R. The control means 140 is coupled to a transmitter 110 for transmission of the first signal via an antenna 130 to the second station 200.

The first radio station 100 also comprises a receiver 120 coupled to the antenna 130 for receiving a second signal transmitted by the second radio station 200, and an output of the receiver 120 is coupled to the processor 160 for processing the received second signal.

The second radio station 200 comprises a receiver 220 coupled to an antenna 230 for receiving the first signal and determining the indications I_{PMAX} and I_{R}. The receiver 220 is coupled to a processor 240 which determines the maximum transmission power level P_{MAX} indicated by I_{PMAX} and the rate of increase of transmission power R indicated by I_{R}. The processor 240 is adapted to generate a second signal, for example comprising data, and is coupled to a transmitter 210 for transmission of the second signal via the antenna 230. The processor 240 is also adapted to control the transmit power of the transmitter 210 as described above with reference to FIG. 1 such that the transmit power for transmission of the second signal is compliant with maximum transmission power level P_{MAX} indicated by I_{PMAX} and the rate of increase of transmission power R indicated by I_{R}.

The indication I_{PMAX} may comprise a variety of alternative forms, for example:
a) An absolute power level;
b) A power level relative to a predetermined reference value or relative to the power level of another signal being transmitted by the second station, where the relative level may be expressed as a ratio;
c) A data rate, or number of bits per unit time, which has an associated implicit power level.

The indication of rate of increase of transmission power I_{R} may be expressed in a variety of forms, for example, one or more of the following:
a) A rate of increase of absolute power;
b) A rate of increase of a power level relative to a predetermined reference value or relative to the power level of another signal being transmitted by the second station, where the relative level may be expressed as a ratio;
c) A rate of increase of a data rate, or rate of increase of a number of bits per unit time, where the data rate or number of bits per unit time has an associated power level.
d) A prescribed time period or minimum time period between steps;
e) A prescribed step size or maximum step size, where the step is expressed as absolute value or a relative increase, and the step is expressed as a step in power, date rate or number of bits per unit time.

Optionally, one value of the indication I_{R} may indicate that the rate of increase is unrestricted, meaning that the second station may freely select its rate of increase without constraint from the first station.

The second station may not be equipped to use precisely the rate indicated by I_{R} or the maximum transmission power indicated by I_{PMAX} due for example to lack of suitable power steps sizes or to lack of precision in setting power levels or to a transmission power limitation or to the need to reserve some transmission power for other signals. In this case the second station may use an available rate of increase of transmission power which is nearest to R, which may be lower or higher than R, or may be restricted to not exceed R. Similarly, the second station may use a maximum transmission power which is nearest to P_{MAX}, which may be lower or higher than P_{MAX}, or may be restricted to not exceed P_{MAX}.

Optionally the second station may not increase its transmission power to the maximum transmission power indicated by I_{PMAX} but instead increase to a lower power level. Optionally the second station may not increase its transmission power at the rate indicated by I_{R} but instead increase its transmission power at a lower rate. These two options may be used in combination. These options may be used for example if the second station does not have sufficient data ready for transmission to employ the indicated maximum transmission power P_{MAX} or a corresponding maximum data rate, or the indicated rate of increase of transmission power R, or corresponding rate of increase of data rate.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communications and transmit power control and which may be used instead of or in addition to features already described herein.

1. A method of operating a radio communication system comprising a first station (100) and a second station (200), the method comprising:
at the first station (100), transmitting a first signal comprising a first indication of a maximum transmission power and a second indication of a selected one of a first plurality of rates of increase of transmission power; and
at the second station (200), receiving the first signal and transmitting a second signal using a step-wise increasing transmission power to approach the indicated maximum transmission power at a rate of increase selected in response to the received second indication.

2. A method of operating a radio communication system as claimed in claim 1, wherein at the second station (200) the rate of increase of transmission power is selected from a second plurality of available rates, the selected rate being the nearest available rate to the rate indicated by the received second indication.

3. A method of operating a radio communication system as claimed in claim 1, wherein at the second station (200) the rate of increase of transmission power is selected from a second plurality of available rates, the selected rate being the nearest available rate to the rate indicated by the received second indication, but not exceeding that indicated rate.

4. A method of operating a radio communication system as claimed in claim 1, wherein at the second station (200) the rate of increase of transmission power is selected to be lower than the rate indicated by the received second indication (I_{R}).

5. A method of operating a radio communication system as claimed in claim 1, wherein the second indication is indicative of a time period between increases of transmission power.

6. A method of operating a radio communication system as claimed in claim 1, wherein the second indication is indicative of a step size in the increase of transmission power.

7. A method of operating a radio communication system as claimed in claim 1, wherein one of the first plurality of rates of increase of transmission power indicates that the second station may select the rate of increase of transmission power without constraint from the first station.

8. A radio station (200) comprising:
receiving means (220) for receiving a first signal comprising a first indication (I_{PMAX}) of maximum transmission power (P_{MAX}) and a second indication (I_{R}) of a selected one of a first plurality of rates of increase of transmission power,
transmitting means (210) for transmitting a second signal, and
control means (240) adapted to increase step-wise the transmission power of the second signal to approach the indicated maximum transmission power at a rate of increase selected in response to the received second indication (I_{R}).

9. A radio station (200) as claimed in claim 8, wherein the control means (240) is adapted to select the rate of increase of transmission power from a second plurality of available rates, the selected rate being the nearest available rate to the rate indicated by the received second indication (I_{R}).

10. A radio station (200) as claimed in claim 8, wherein the control means (240) is adapted to select the rate of increase of transmission power from a second plurality of available rates, the selected rate being the nearest available rate to the rate indicated by the received second indication (I_{R}), but not exceeding that rate.

11. A radio station (200) as claimed in claim 8, wherein the control means (240) is adapted to select the rate of increase of transmission power to be lower than the rate indicated by the received second indication (I_{R}).

12. A radio station (200) as claimed in claim 8, wherein the second indication (I_{R}) is indicative of a time period between increases of transmission power.

13. A radio station (200) as claimed in claim 8, wherein the second indication (I_{R}) is indicative of a step size in the increase of transmission power.

14. A radio station (200) as claimed in claim 8, wherein the control means (240) is adapted to interpret one of the first plurality of rates of increase of transmission power as permitting the radio station to select the rate of increase of transmission power without external constraint.

15. A radio station (100) comprising control means (140) adapted to generate for transmission a first signal comprising a first indication (I_{PMAX}) of a maximum transmission power (P_{MAX}) and a second indication (I_{R}) of a selected one of a first plurality of rates of increase of transmission power, and transmission means for transmitting the first signal.

16. A radio station (100) as claimed in claim 15, wherein the second indication (I_{R}) is indicative of a time period between increases of transmission power.

17. A radio station (100) as claimed in claim 15, wherein the second indication (I_{R}) is indicative of a step size in the increase of transmission power.

18. A radio communication system comprising a first radio station (100) as claimed in claim 15 and a second radio station (200) comprising:
receiving means (220) for receiving a first signal comprising a first indication (I_{PMAX}) of maximum transmission power (P_{MAX}) and a second indication (I_{R}) of a selected one of a first plurality of rates of increase of transmission power,
transmitting means (210) for transmitting a second signal, and
control means (210) adapted to increase step-wise the transmission power of the second signal to approach the indicated maximum transmission power at a rate of increase selected in response to the received second indication (I_{R}).

19. A signal comprising a first indication (I_{PMAX}) of a maximum transmission power (P_{MAX}) and a second indication (I_{R}) of a selected one of a plurality of rates of increase of transmission power.

20. A signal as claimed in claim 19, wherein the second indication (I_{R}) is indicative of a time period between increases of transmission power.

21. A signal as claimed in claim 19, wherein the second indication (I_{R}) is indicative of a step size in the increase of transmission power.
